(19) United States
(12) Patent Application Publication
(10) Pub. No.: US 2012/0054105 A1
(43) Pub. Date: Mar. 1, 2012

(54) SYSTEM FOR SAFE MONEY TRANSFER

(76) Inventor: Dong Seok Seo, Seoul (KR)

(21) Appl. No.: 13/318,073

(22) PCT Filed: Jan. 27, 2010
(86) PCT No.: PCT/KR2010/000482

§ 371 Date: Oct. 28, 2011

(30) Foreign Application Priority Data
May 15, 2009 (KR) 10-2009-0042685
Sep. 11, 2009 (KR) 10-2009-0086109

(51) Int. Cl. G06Q 20/40

(52) U.S. Cl. 705/44

(57) ABSTRACT

The present invention provides a system for safe money transfer, which transfers money from a secure bank account, comprises a mediation server receiving a request for approval from an requester to transfer the money and generating a request message including the request for approval; an approval terminal receiving the request message from the mediation server, generating an approval for request to approve the request for approval and sending the approval for request to the mediation server by an approver; and a security transaction server receiving the approval for request from the approval terminal via the mediation server, thereby allowing the money to be transferred. Preferably, the system further comprises a request terminal sending the request for approval to the mediation server by the requester; and an accounting part proceeding with transferring the money if the security transaction server sends the request for approval to the accounting part.

### TECHNICAL FIELD

The present invention relates to a system for safe money transfer, and particularly a system for safe money transfer which requires an approver's approval for a requester's money transfer before carrying out the money transfer.

### BACKGROUND ART

Many companies essentially open a bank account and transfer money for various purposes. Generally, an accounting department handles the company's money transfer. In order to prevent an employee from embezzling money on the bank account of the company, a superior has to approve the money transfer before the bank actually transfers the money.

However, if the employee plans to embezzle the company's money, he or she can easily transfer the money to another bank account or withdraw cash from an ATM without the superior's approval.

Accordingly, for a long time there has been demand for a system that prevents the employee's embezzlement or banking mistake by his or her superior, or for allowing the superior to approve the money transfer anywhere.

### DISCLOSURE OF INVENTION

### Technical Problem

The purpose of the present invention is to provide a system for safe money transfer, in which the information about a money transfer is promptly provided to the users of the system, and the approval for a money transfer is available before the money transfer is carried out.

### Solution to Problem

In order to achieve the above purpose, the present invention provides a system for safe money transfer, which transfers money from a secure bank account, comprises a mediation server receiving a request for approval from an requester to transfer the money and generating a request message including the request for approval; an approval terminal receiving the request message from the mediation server, generating an approval for request to approve the request for approval and sending the approval for request to the mediation server by an approver; and a security transaction server receiving the approval for request from the approval terminal via the mediation server, thereby allowing the money to be transferred. Preferably, the system further comprises a request terminal sending the request for approval to the mediation server by the requester; and an accounting part proceeding with transferring the money if the security transaction server sends the request for approval to the accounting part.

If the mediation server receives the approval for request from the approval terminal, the mediation server generates an approval message including the approval for request and sends the approval message to the request terminal.

If the request message is activated on the approval terminal, an authorized software connects the approval terminal to the mediation server and displays the request for approval included in the request message on the approval terminal.

If the approval terminal does not approve the request for approval during a validity time, the request for approval is canceled. If the request for approval is canceled in the approval terminal, the mediation server generates a cancellation message including the canceled request for approval and sends the cancellation message to the request terminal.

The authentication data of the approver are stored in the approval terminal; sent to the security transaction server via the mediation server with the approval for request; and verified in the security transaction server to transfer the money. The authentication data of the requester are stored in the request terminal; sent to the security transaction server via the mediation server with the request for approval; and verified in the security transaction server to transfer the money.

The approval terminal is selected from a list of a plurality of approval terminals according to the amount of the money by the security transaction server, and receives the request message from the mediation server.

The security transaction server receives the request for approval from the mediation server after the mediation server receives the request for approval from the requester, and identifies whether the request for approval is applied to the secure bank account. If the request for approval is for the secure bank account, the security transaction server stops transferring the money and requires the mediation server to send the request message to the request terminal. If the request for approval is not for the secure bank account, the security transaction server requires the accounting part to proceed with transferring the money.

The system for safe money transfer may further comprise an authentication server connected by the approval terminal or the request terminal to verify an authenticity of the approver or the requester. The request terminal connects to the authentication server to verify the authenticity of the requester when the request terminal sends the request for approval to the mediation server. The approval terminal connects to the authentication server to verify the authenticity of the approver when the approval terminal sends the approval for request to the mediation server. After the verification is completed, the authentication server sends a verification result to the security transaction server via the mediation server.

### Advantageous Effects of Invention

In the system for safe money transfer according to the present invention, money transfer is safely managed by preventing employees or third parties from transferring money in a bank account without approval. Furthermore, the procedures of requesting an approval and approving a request are greatly simplified and safely proceed by verification of the user's authenticity.

The system for safe money transfer according to the present invention can be easily applied to the conventional money-transferring systems of banks, and allows users to promptly request an approval and approve a request anywhere.

### BRIEF DESCRIPTION OF DRAWINGS

FIG. 1 shows a system for safe money transfer according to an embodiment of the present invention.

FIG. 2 shows the procedures that the system for safe money transfer proceeds with money transfer.

FIG. 3 shows the steps by which an authorized software is installed in an approval terminal.

FIG. 4 shows the steps by which an approval for request proceeds in the approval terminal.

FIG. 5 shows the steps by which a request for approval proceeds in a request terminal.

FIG. 6 shows a system for safe money transfer according to another embodiment of the present invention.

### MODE FOR THE INVENTION

Hereinafter, a system for safe money transfer according to an embodiment of the present invention will be explained in more detail with reference to the accompanying drawings.

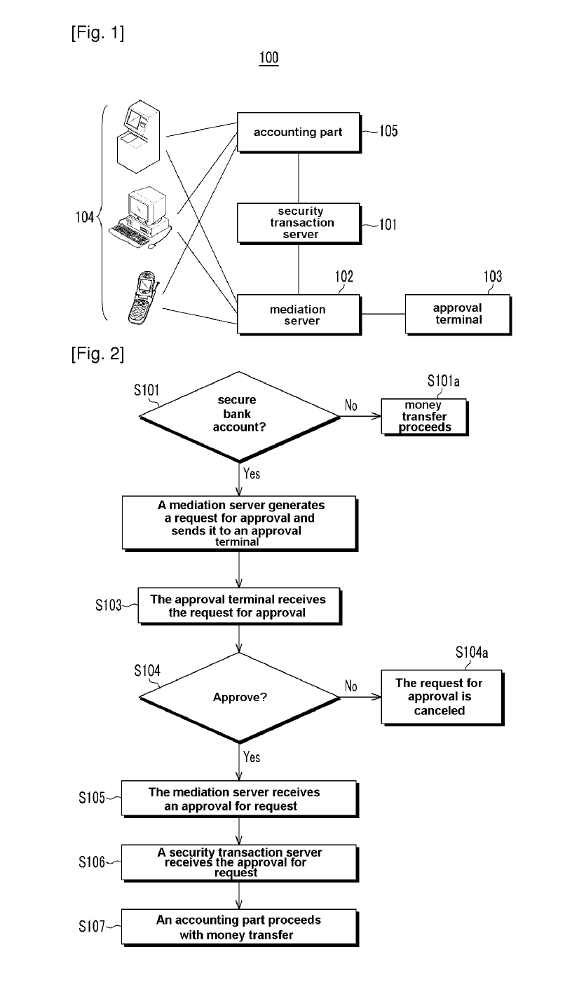

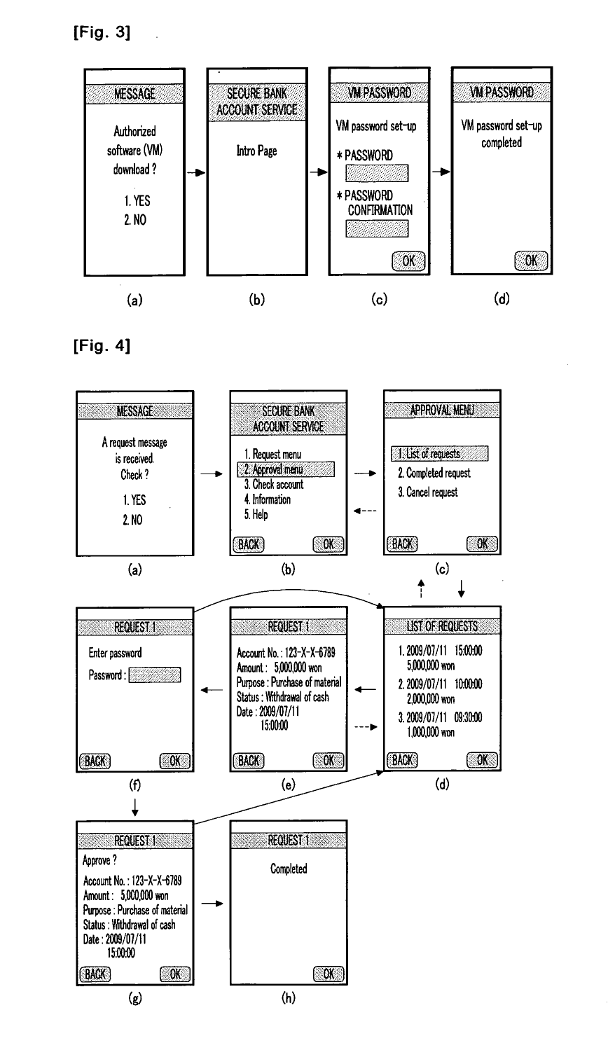

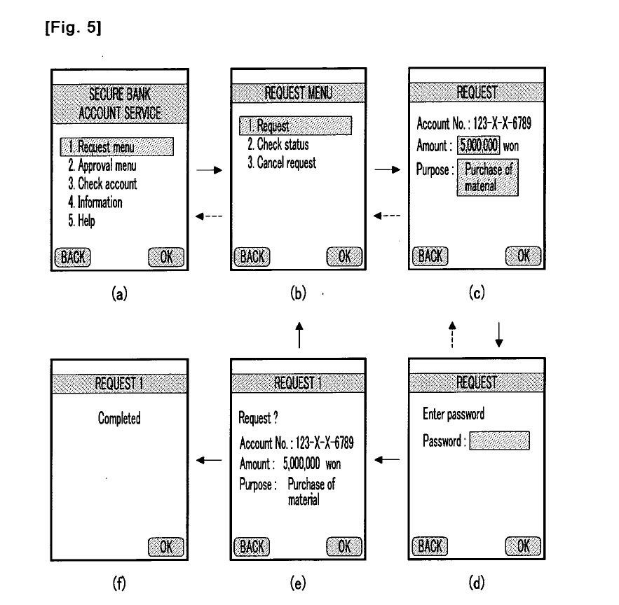

FIG. 1 shows a system for safe money transfer according to an embodiment of the present invention. FIG. 2 shows the procedures that the system for safe money transfer proceeds with money transfer. FIG. 3 shows the steps by which an authorized software is installed in an approval terminal. FIG. 4 shows the steps by which an approval for request proceeds in the approval terminal. FIG. 5 shows the steps by which a request for approval proceeds in a request terminal.

As shown in FIGS. 1 to 5, the system for safe money transfer according to the present embodiment comprises a security transaction server 101, a mediation server 102, an approval terminal 103, a request terminal 104 and an accounting part 105, thereby proceeding with the money transfer.

The term “money transfer” includes the money transfer between more than two bank accounts and withdrawal of cash from ATM.

The term “requester” means the person who requests the approval for money transfer, usually an employee in the accounting department.

The term “approver” means the person who can approve the requester's request for approval, usually the requester's superior in the company—for example, a department head, an executive director, a CEO, etc.

The term “secure bank account” means the bank account which is registered to the bank to use the system for safe money transfer. The accounting part 105 designates the bank account, which the user applies for the system for safe money transfer, as the secure bank account, and sends the information about the secure bank account to the security transaction server 101. The security transaction server 101 may require the mediation server 102 to send an installation message to the approval terminal 103 to help the approver install the authorized software on the approval terminal 103.

As shown in FIGS. 1 and 2, a requester applies for a money transfer to the bank, using the request terminal 104 such as an ATM, a bank teller's terminal, a computer using an Internet banking service or a cellular phone using a phone banking service, which is referred to as the step of generating a request for approval. The request terminal 104 sends the request for approval to the mediation server 102.

The mediation server 102 receives the request for approval from the request terminal 104 and then sends the request for approval to the security transaction server 101. The security transaction server 101 identifies whether the bank account, from which money is transferred according to the request for approval, is a secure bank account (S101).

If the bank account corresponding to the request for approval is not a secure bank account, the money transfer proceeds in the security transaction server 101 or the accounting part 105 according to the request for approval (S101a).

If the bank account corresponding to the request for approval is a secure bank account, the security transaction server 101 stops proceeding with the money transfer, and sends the request for approval back to the mediation server 102. Before the security transaction server 101 sends the request for approval to the mediation server 102, the request for approval may be stored on the security transaction server 101.

The mediation server 102 generates a request message that includes the request for approval and sends the request message to the approval terminal 103 (S102). The request message may be a URL callback short message or a bidirectional short message.

The approval terminal 103 receives the request message and displays it on the approval terminal 103 (S103). Accordingly, the approver can recognize that the request for the money transfer is standing by in the bank through the request message displayed on the approval terminal 103. The approval terminal 103 may be a mobile communication terminal such as cellular phones, laptop computers and PDAs but is not limited thereto.

If the approval terminal 103 activates the request message, the approval terminal 103 can check the contents of the request for approval by displaying the request for approval (S104).

If the approver does not approve the request for approval, the money transfer corresponding to the request for approval is canceled (S104a). In this case, the mediation server 102 generates a cancellation message which includes the canceled request for approval and sends the cancellation message to the request terminal 104. The security transaction server 101 invalidates the stored request for approval.

If the approver does not respond to the request message or the request for approval during a certain period, which is referred to as “validity time,” the request for approval is automatically canceled. The validity time may be set by the requester in the request terminal 104, for example, the time of bank closing, some hours after the approval request, a specified time, etc.

If the approver approves the request for approval, the approval terminal 103 generates an approval for request and sends it to the mediation server 102 (S105).

The mediation server 102 sends the approval for request to the security transaction server 101 (S106). Furthermore, the mediation server 102 generates an approval message which includes the approval for request and sends the approval message to the request terminal 104, whereby the requester can recognize that the approver approved the request for approval.

The security transaction server 101 proceeds with the stopped money transfer after receiving the approval for request from the mediation server 102. If the system for safe money transfer comprises the accounting part 105, the security transaction server 101 sends the request for approval to the accounting part 105, which proceeds with the stopped money transfer (S107).

If the money transfer is to withdraw cash from an ATM, the requester can withdraw cash up to the approved amount only after receiving the approval message.

The security transaction server 101 may have the function of the accounting part of a conventional banking institution. In this case, the system for safe money transfer does not need to further comprise the accounting part 105, and the security transaction server 101 can proceed with the money transfer.

The system for safe money transfer according to the present embodiment can have a plurality of approvers per secure bank account. The security transaction server 101 has a list of approvers, selects the approver according to the account of money to be transferred, and requires the mediation server 102 to send the request for approval to the approval terminal 103 of the selected approver.

For example, a company may have a department head, an executive director and a CEO as approvers. The amount of money to be transferred that the CEO can approve can be set as more than that of the executive director or department head.

The system for safe money transfer according to the present embodiment can also proceed with a money transfer without stopping it in the security transaction server 101 if the amount of money to be transferred is below a certain amount or the money transfer is for regularly transferring money such as paying utility bills or taxes, or paying back a loan. That is, the mediation server 102 does not send the request for approval to the approval terminal 103. In this case, the mediation server 102 may send the request for approval back to the requester in order to notify it that the money transfer does not need to be approved.

By the authorized software, the approval terminal 103 connects to the mediation server 102, displays the request for approval thereon and approves the request for approval. The authorized software may be an application program or virtual machine that is installed and run in the approval terminal 103. The mediation server 102 always verifies whether the communication with the approval terminal 103 is performed by the authorized software.

The authorized software is stored in the mediation server 102 or another individual storage server (not shown). The approval terminal 103 connects to the mediation server 102, downloads the authorized software from the mediation server 102 and installs the authorized software in the approval terminal 103.

In case the authorized software cannot be installed in the approval terminal 103, the authorized software may be used in a Web page provided by the mediation server 102. The approver may visit the Web page, in which the authorized software can be run after the authenticity of the approver is verified by authentication data.

The approval terminal 103 stores authentication data therein. The authentication data are used to identify the authenticity of the approver and may be passwords, authentication certificates of electronic banking, temporary password generators, password cards for electronic banking, etc. The password used for the authentication data can be changed by the approver, using the authorized software.

The authentication data is sent from the approval terminal 103 to the mediation server 102 and verified in the security transaction server 101. After the authenticity is admitted, the approval for request is sent from the mediation server 102 to the security transaction server 101 to proceed with the stopped money transfer.

In the present embodiment, it will be exemplified that the authorized software is installed in the approval terminal 103, and the authentication data is the password which is set by the approver.

As shown in FIG. 3(a), the approval terminal 103 displays the installation message which is transferred from the mediation server 102. The installation message, which is a type of a URL callback short message or a bidirectional short message, inquires whether the approver downloads and installs the authorized software.

If the approver chooses to download the authorized software, the approval terminal 103 downloads the authorized software from the mediation server 102 and installs it in the approval terminal 103. In this case, the approval terminal 103 displays an intro page for installation as shown in FIG. 3(b).

As shown in FIGS. 3(c) and 3(d), the authorized software is run after the installation and then requires the approver to set the password as the authentication data. If the password is set, it is securely coded—for example, changed into hash values—and then sent to the mediation server 102. The mediation server 102 sends the securely coded password to the security transaction server 101, and then the security transaction server 101 stores the securely coded password therein.

The request for approval and the approval for request which the approver has already approved can be displayed on the approval terminal 103 by the authorized software. Whenever the mediation server 102 sends the request for approval, the mediation server 102 verifies whether the authorized software is normally installed in the approval terminal 103. If the authorized software is normally installed in the approval terminal 103, the authorized software displays the request for approval on the approval terminal 103. If the authorized software is not normally installed in the approval terminal 103, the above installation process starts.

As shown in FIG. 4(a), the approver can recognize the request for approval by activating the request message on the approval terminal 103. If the request message is activated (i.e., choosing “yes” in FIG. 4(a)), the authorized software is run to display the request for approval.

If the mediation server 102 detects that the authorized software is not run on the approval terminal 103 after the request message is activated, the request for approval may be automatically canceled.

As shown in FIGS. 4(b) to 4(e), the approver can check the request for approval by choosing “approval menu” in FIG. 4(b) and “list of requests” in FIG. 4(c) on the menu of the authorized software.

As shown in FIG. 4(e), the request for approval comprises the information about an account number, a transferring date, the amount of money to be transferred, a note, etc. The account number means the number of the secure bank account. The note comprises the information that the requester wants to explain to the approver—for example, “purchase of material,” “paying a tax,” etc.

As shown in FIGS. 4(f) to 4(h), the approver can approve the request for approval by choosing “ok” in FIG. 4(d) and typing the password on the menu. The securely coded password and the approval for request which is generated by choosing “ok” in FIG. 4(g) are then sent to the security transaction server 101 via the mediation server 102.

The security transaction server 101 compares the typed password and the stored password, and if they match, the stopped money transfer proceeds and is completed. The completed approvals for request can be checked on the menu of the authorized software (“completed approval for request” in FIG. 4(c)).

As shown in FIGS. 5(a) to 5(c), the requester generates the request for approval on the menu of the authorized software by choosing “request menu” in FIG. 5(a) and “resuest” in FIG. 5(b).

The request terminal 104 can connect to the mediation server 102 by the authorized software to send the request for approval and receive the approval message or the cancellation message. The authorized software may be an application program or virtual machine that is installed and run in the request terminal 104.

The request terminal 104 stores authentication data therein. The authentication data are used to identify the authenticity of the requester and may be a password, an authentication certificate of electronic banking, a temporary password generator, a password card for electronic banking, etc. The password for the authentication data can be changed by the requester, using the authorized software.

As shown in FIGS. 5(d) to 5(f), the authorized software requires the requester to type the password as the authentication data. After typing the password on the menu, the password is securely coded and sent to the security transaction server 101 via the mediation server 102 along with the request for approval. The security transaction server 101 compares the typed password and the stored password, and if they match, the request for approval is sent from the mediation server 102 to the approval terminal 103.

The system for safe money transfer according to the present invention can be used for a private money transfer. In this case, a requester and an approver are the same user—the owner of a secure bank account. In order to transfer money, the user generates a request for approval on the approval terminal 103, sends the request for approval to the mediation server 102, receives the request for approval from the mediation server 102 and approves the request for approval on the approval terminal 103. The user does not need to use the request terminal 104. Therefore, a third party cannot transfer money from the user's bank account without the user's approval, which can assure the safe money transfer.

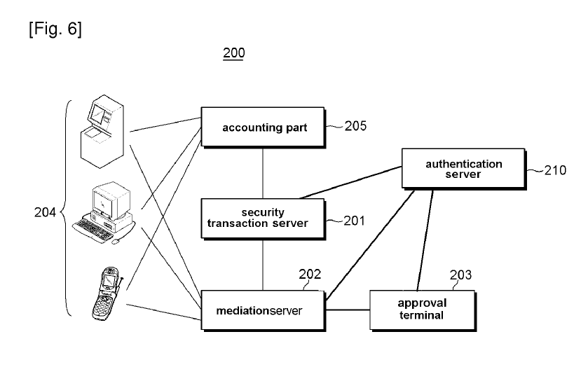

FIG. 6 shows a system for safe money transfer according to another embodiment of the present invention. As shown in FIG. 6, the system for safe money transfer according to another embodiment of the present invention comprises a security transaction server 201, a mediation server 202, an approval terminal 203, a request terminal 204 and an accounting part 205, thereby proceeding with the money transfer.

The system 200 according to this embodiment further comprises an authentication server 210 which is a separate individual server, unlike the system 100 according to the previous embodiment.

Because the authentication data of the requester and the approver are stored in the authentication server 210, the approval terminal 203 and the request terminal 204 do not store the authentication data therein. The request terminal 204 connects to the authentication server 210 to verify the authenticity of the requester when the request terminal 204 sends the request for approval to the mediation server 202. The approval terminal 203 connects to the authentication server 210 to verify the authenticity of the approver when the approval terminal 203 sends the approval for request to the mediation server 202. The authentication server 210 sends the verification results to the security transaction server 201 via the mediation server 202. The authentication server 210 may be shared by many banks which use the system for safe money transfer according to the present invention.

From the above embodiment of the present invention, it is noted that modifications and variations could be made by a person skilled in the art in light of the above teachings. Therefore, it should be understood that changes may be made for a particular embodiment of the present invention within its scope and spirit outlined by the appended claims.

1. A system for safe money transfer, the system transferring money from a secure bank account, comprising:
a mediation server receiving a request for approval from an requester to transfer the money and generating a request message including the request for approval;
an approval terminal receiving the request message from the mediation server, generating an approval for request to approve the request for approval and sending the approval for request to the mediation server by an approver; and
a security transaction server receiving the approval for request from the approval terminal via the mediation server, thereby allowing the money to be transferred.

2. The system for safe money transfer according to claim 1, further comprising:
a request terminal sending the request for approval to the mediation server by the requester.

3. The system for safe money transfer according to claim 2,
wherein the mediation server, which receives the approval for request from the approval terminal, generates an approval message including the approval for request and sends the approval message to the request terminal.

4. The system for safe money transfer according to claim 1,
wherein if the request message is activated on the approval terminal, an authorized software connects the approval terminal to the mediation server and displays the request for approval included in the request message on the approval terminal.

5. The system for safe money transfer according to claim 1,
wherein authentication data are stored in the approval terminal; sent to the security transaction server via the mediation server with the approval for request; and verified in the security transaction server to transfer the money.

6. The system for safe money transfer according to claim 1,
wherein the approval terminal is selected from a list of a plurality of approval terminals according to the amount of the money by the security transaction server, and receives the request message from the mediation server.

7. The system for safe money transfer according to claim 2, further comprising:
an accounting part proceeding with transferring the money if the security transaction server sends the request for approval to the accounting part.

8. The system for safe money transfer according to claim 7,
wherein the security transaction server receives the request for approval from the mediation server after the mediation server receives the request for approval from the requester, and identifies whether the request for approval is applied to the secure bank account,
wherein if the request for approval is for the secure bank account, the security transaction server stops transferring the money and requires the mediation server to send the request message to the request terminal, and
wherein if the request for approval is not for the secure bank account, the security transaction server requires the accounting part to proceed with transferring the money.

9. The system for safe money transfer according to claim 2,
wherein if the request for approval is canceled in the approval terminal, the mediation server generates a cancellation message including the canceled request for approval and sends the cancellation message to the request terminal.

10. The system for safe money transfer according to claim 9,
wherein if the approval terminal does not approve the request for approval during a validity time, the request for approval is canceled.

11. The system for safe money transfer according to claim 2,
wherein authentication data are stored in the request terminal; sent to the security transaction server via the mediation server with the request for approval; and verified in the security transaction server to transfer the money.

12. The system for safe money transfer according to claim 2, further comprising:
an authentication server connected by the approval terminal or the request terminal to verify an authenticity of the approver or the requester,
wherein the request terminal connects to the authentication server to verify the authenticity of the requester when the request terminal sends the request for approval to the mediation server,
wherein the approval terminal connects to the authentication server to verify the authenticity of the approver when the approval terminal sends the approval for request to the mediation server, and
wherein the authentication server sends a verification result to the security transaction server via the mediation server.
